(19) United States
(12) Patent Application Publication
(10) Pub. No.: US 2020/0290834 A1
(43) Pub. Date: Sep. 17, 2020

(54) CONVEYING DEVICE

(71) Applicant: TOYOTA JIDOSHA KABUSHIKI KAISHA, Toyota-shi (JP)

(72) Inventor: Takuo YANAGI, Toyota-shi (JP)

(21) Appl. No.: 16/791,027

(22) Filed: Feb. 14, 2020

(30) Foreign Application Priority Data
Mar. 15, 2019 (JP) 2019-048682

(51) Int. Cl. B65H 20/02; H05B 6/64; F26B 5/02; B05D 3/02; H01M 4/04; H01M 10/0585

(52) U.S. Cl. CPC B65H 20/02; H05B 6/64; F26B 5/02; H01M 10/0585; H01M 4/0471; H01M 4/0404; B05D 3/0272

(57) ABSTRACT

The present invention provides a conveying device and a conveyance method that can improve manufacturing efficiency for the target object and reduce apparatus costs.

A conveying device for conveying a strip sheet has a double spiral route comprising a first spiral route from an outer side toward a. center side and a second spiral route from the center side toward an outer side connected successively in this order, and the first spiral route and the second spiral route are each composed of a plurality of conveyor rollers.

### FIELD

The present disclosure relates to a conveying device. In particular, the present disclosure relates to a conveying device for conveying a strip sheet.

### BACKGROUND

Various methods for applying a coating layer to a strip sheet and for surface treating a strip sheet, such as etching, pattern forming, or roughening, are known. In particular, in the process for manufacturing a strip sheet having a coating layer, the technique of applying a coating liquid or slurry to the strip sheet and then drying the coating liquid or slurry is commonly practiced.

For example, Patent Literature 1 discloses a technique where, during manufacture of a battery electrode plate, a coater which intermittently applies and dries an electrode mixture layer coating liquid to one side of a current collector and then to the other side of the current collector in succession is used to intermittently apply and dry the coating on one surface of the current collector.

Additionally, Patent Literature 2 discloses a technique for manufacturing a lithium secondary battery comprising a step where, while removing Fe-based metal contaminants present in a slurry at a die head equipped with an iron removal means, the slurry is applied to metal foils through the die head and dried, and a step of interposing a separator between the metal foils coated with the slurry, and winding this laminate in a spiral shape to create electrodes.

Further, Patent Literature 3 discloses a technique for forming a coating membrane for a coil by applying a coating to one surface of a chip-type core in a spiral shape and then drying.

In the manufacture of strip sheets having a coating layer, normally, there is a step in which the strip sheet coated with coating liquid or slurry is conveyed to a drying apparatus and dried.

In order to reduce costs of the devices, such as the drying apparatus, reducing the length of the drying apparatus has been proposed.

For example, Patent Literature 4 discloses a strip-shaped body drying apparatus for drying a strip-shaped body comprising a coated surface covered by a coating material, the coated surface having a coated part which is successively coated with a coating material along the conveyance direction and an uncoated part which is not coated with a coating material, wherein the strip-shaped body drying apparatus comprises: a drying furnace for drying the strip-shaped body; an uneven roller for conveying the strip-shaped body in a predetermined direction, comprising a roller protrusion part which contacts and supports the uncoated part on the coated surface side of the strip-shaped body, and a roller recess part provided with vents for delivering air for drying the coating material applied on the strip-shaped body; and an air-blowing means for delivering air through the vents provided in the roller recess part toward the side of the strip-shaped body surface contacted and supported by the roller protrusion part, and wherein the conveyor route of the strip-shaped body in the drying furnace is bent using the uneven roller.

### CITATION LIST

### Patent Literature

[Patent Literature 1] Japanese Unexamined Patent Publication (Kokai) No. 2004-214140
[Patent Literature 2] Japanese Unexamined Patent Publication (Kokai) No. 2010-135238
[Patent Literature 3] Japanese Unexamined Patent Publication (Kokai) No. 2003-51412
[Patent Literature 4] Japanese Unexamined Patent Publication (Kokai) No. 2010-225467

### SUMMARY

### Technical Problem

There is demand for technology that, not only for drying apparatuses, but also for various apparatuses (for example, curing apparatuses, water repellent treatment apparatuses, and hydrophilic treatment apparatuses), reduces apparatus costs while improving production efficiency of the target in a process for manufacturing or producing a strip-shaped target.

However, if the conveyance speed is raised to improve production efficiency of a target, the drying apparatus needs to be longer. Thus, it is difficult to restrict costs of the apparatus. Essentially, it is problematic to achieve both improvement in production efficiency of a target and reduction in costs of the apparatus.

Therefore, the present disclosure has the object, out of consideration of the above circumstances, of providing a conveying device for strip sheets, a conveying method for strip sheets, a method for manufacturing a coating layer, and a method for manufacturing surface treated strip sheets, which can achieve both improvement in the production efficiency of a target and reduction in costs of the apparatus.

### Solution to Problem

The present inventors of the present disclosure discovered that the above problem could be solved by the following means.

### <Aspect 1>

A conveying device for conveying a strip sheet, comprising a double spiral route comprising a first spiral route from an outer side toward a center side and a second spiral route from the center side toward an outer side connected successively in this order, wherein the first spiral route and the second spiral route are each composed of a plurality of conveyor rollers.

### <Aspect 2>

The conveying device according to aspect 1, wherein the first spiral route and the second spiral route are both angular spirals.

### <Aspect 3>

The conveying device according to aspect 2, wherein the angular spirals are square spirals.

### <Aspect 4>

The conveying device according to any one of aspects 1 to 3, wherein a gap between the first spiral route and the second spiral route is substantially constant.

### <Aspect 5>

The conveying device according to any one of aspects 1 to 4, wherein at least a part of one surface of the strip sheet is covered by a coating layer or a treatment agent layer.

### <Aspect 6>

The conveying device according to aspect 5, further comprising a treatment apparatus for treating the coaling layer or treatment agent layer, which is untreated, in the double spiral route to obtain the coating layer which has been treated or the strip sheet which has been surface treated.

### <Aspect 7>

The conveying device according to aspect 6, wherein the treatment apparatus is at least one of a drying apparatus and a chemical treatment apparatus.

### <Aspect 8>

The conveying device according to aspect 7, wherein the drying apparatus is at least one selected from the group consisting of a fan, an ultrasonic oscillator, a heater, and a decompressor.

### <Aspect 9>

The conveying device according to aspect 7, wherein the chemical treatment apparatus is at least one selected from the group consisting of a curing apparatus, a water repellent treatment apparatus, a hydrophilic treatment apparatus, and a plasma treatment apparatus.

### <Aspect 10>

The conveying device according to any one of aspects 5 to 9, wherein a raw material of the coating layer is an active material layer slurry or a solid electrolyte layer slurry.

### <Aspect 11>

The conveying device according to any one of aspects 5 to 9, wherein a raw material of the treatment agent layer is an etchant or a treatment liquid for patterning.

### <Aspect 12>

A conveying method using the conveying device according to any one of aspects 5 to 11, comprising contacting a surface of the strip sheet covered by the coating layer or the treatment agent layer, and the opposite surface thereof with the plurality of conveyor rollers composing the first spiral route, and contacting the surface of the strip sheet covered by the coating layer, or a surface of the strip sheet surface treated with a treatment agent of the treatment agent layer with the plurality of conveyor rollers composing the second spiral route.

### <Aspect 13>

A method for manufacturing a coating layer, comprising using the conveying method according to aspect 12 to treat the coating layer, which is untreated, in the second spiral route, and obtain the coating layer which has been treated.

### <Aspect 14>

The method according to aspect 13, wherein the treatment is at least one of a drying treatment and a chemical treatment.

### <Aspect 15>

The method according to aspect 14, wherein the drying treatment is at least one of a natural drying treatment, a hot air drying treatment, an IR heat drying treatment, a microwave heat drying treatment, an ultrasonic drying treatment, and a vacuum drying treatment.

### <Aspect 16>

The method according to any one of aspects 13 to 15, wherein the coating layer is an active material layer or a solid electrolyte layer.

### <Aspect 17>

A method for manufacturing a surface treated strip sheet, comprising surface treating a strip sheet with a treatment agent of a treatment agent layer in a double spiral route, using the conveying method according to aspect 12.

### Advantageous Effects of Invention

According to the conveying device and conveying method of the present disclosure, both improvement in production efficiency for a target and reduction in apparatus costs can be achieved.

### BRIEF DESCRIPTION OF DRAWINGS

FIG. 1 is a schematic diagram showing one embodiment of the conveying device of the present disclosure.

FIG. 2 is a schematic diagram of performing a dry treatment using the conveying device of Example 1.

FIG. 3 is a schematic diagram of performing a dry treatment using the conveying device of Comparative Example 1.

FIG. 4 is a schematic diagram of performing a dry treatment using the conveying device of Comparative Example 2.

FIG. 5 is a schematic diagram of performing a dry treatment using the conveying device of Comparative Example 3.

### DESCRIPTION OF EMBODIMENTS

The embodiments for the purpose of realizing the present disclosure will be explained in detail below with reference to the drawings. For the sake of convenience, identical or corresponding parts in each diagram are assigned the same reference sign, so as to eliminate redundant explanations. Each component of the realized embodiment is not necessarily indispensable, and in some cases a portion of the components can be omitted. However, the embodiments shown in the following diagrams are examples of the present disclosure, and do not limit the present disclosure.

### <<Conveying Device>>

The conveying device of the present disclosure is a conveying device for conveying a strip sheet, comprising a double spiral route comprising a first spiral route from an outer side toward a center side and a. second spiral route from the center side toward an outer side connected successively in this order, wherein the first spiral route and the second spiral route are each composed of a plurality of conveyor rollers.

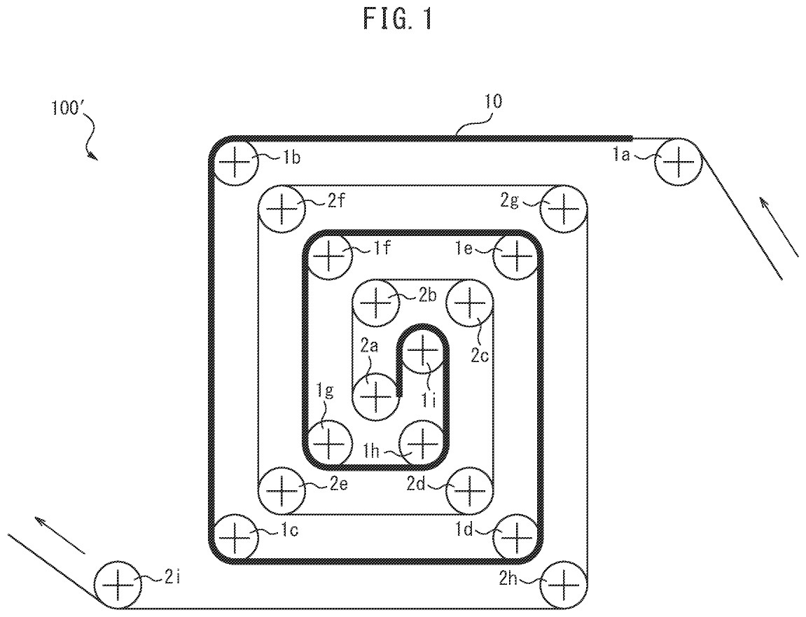

FIG. 1 is a schematic diagram showing one embodiment of the conveying device of the present disclosure.

The conveying device 100′ of the present disclosure shown in FIG. 1 is for conveying a strip sheet 10. The conveying device 100′ has a double spiral route comprising a first spiral route (indicated with a bold line) from an outer side toward a center side and the second spiral route (indicated with a fine line) from the center side toward an outer side connected successively in this order.

The first spiral route (indicated with a bold line) is composed of a plurality of conveyor rollers 1a, 1b, . . . , 1h and 1i. Additionally, the second spiral route (indicated with a fine line) is composed of a plurality of conveyor rollers 2a, 2b, . . . , 2h and 2i.

### <Double Spiral Route>

By providing the conveying device of the present disclosure with the above double spiral route, a conveyance route longer than a route that is not a double spiral route, such as a linear route or a bent route as in Reference 4, can be secured in the middle of an apparatus having a definite size. As a result, both improvement in production efficiency of a target and reduction in apparatus costs can be achieved.

In the double spiral route of the present disclosure, the shapes of the first spiral route and second spiral route are not particularly limited, and can be circular or angular spirals. From the perspective of increasing production efficiency, it is preferable that both the first spiral route and second spiral route be angular spirals.

“Angular spiral” refers to a shape wherein three adjacent conveyor rollers form a constant angle not an arc when connected. The “angle” here is not necessarily an “angle” in the strict sense, but can be a loose angle that has some roundness owing to the shape of the conveyor rollers.

The angular spiral can be any polygon, such as a triangle, square, pentagon, hexagon, heptagon, or octagon. In particular, from the perspective of improving production efficiency, the angular spiral is preferably a square spiral. Essentially, it is preferable that both the first spiral route and the second spiral route be square spirals. It is preferable that the double spiral route composed of the square spirals also be a square spiral.

For example, the conveying device 100′ of the present disclosure shown in FIG. 1 has a double spiral route comprising a first spiral route from an outer side toward a center side and a second spiral route from the center side toward an outer side connected successively in this order.

In the double spiral route of the present disclosure, it is preferable that the gap between the first spiral route and the second spiral route be roughly constant.

For example, in the conveying device 100′ of the present disclosure shown in FIG. 1, the gap between the first spiral route composed of the plurality of conveyor rollers 1a, 1b, . . . , 1h, and 1i and the second spiral route composed of the plurality of conveyor rollers 2a, 2b, . . . , 2h, and 2i is roughly constant.

### <Strip Sheet>

The conveying device of the present disclosure is a device for conveying a strip sheet.

The strip sheet is a sheet having a length that can be wound around a winding roller, and can have, for example, a rectangular shape having a length and width, or a shape that resembles a rectangular shape.

The material of the strip sheet is not particularly limited, and materials appropriate for the purpose and use can be used.

For example, in the case of manufacturing an electrode body for a battery, the material of the strip sheet can be a material that could become a current collector. More specifically, the material of the strip sheet can be, for example, a metal such as SUS, aluminum, copper, nickel, iron, or titanium, or carbon.

The material of the strip sheet can also be a resin material. The strip sheet can be formed of an individual resin, a laminate body of a plurality of resin layers, or a laminate body of a resin layer, a metal layer, and another layer.

The resin material can be, for example, polypropylene, polyethyleneterephthalate, or polystyrene, but is not limited thereto.

The strip sheet may have a single layer configuration, or a configuration of two or more layers. If the strip sheet has a configuration of two or more layers, the materials of the strip sheet stated above can be different or the same for each layer.

The thickness of the strip sheet is not particularly limited, and can be, for example, not less than 1 μm, not less than 2 μm, not less than 3 μm, not less than 4 μm, not less than 5 μm, not less than 6 μm, not less than 7 μm, not less than 8 μm, not less than 9 μm, not less than 10 μm, not less than 15 μm, not less than 20 μm, not less than 30 μm, not less than 40 μm, or not less than 50 μm, and not more than 200 μm, not more than 150 μm, not more than 100 μm, not more than 50 μm, not more than 40 μm, not more than 30 μm, or not more than 20 μm.

In the present disclosure, at least a portion of one surface of the strip sheet can be covered in a coating layer or a treatment agent layer.

The coating layer can be obtained by applying a coating liquid or a slurry onto the strip sheet. The treatment agent layer can be obtained by applying a treatment agent onto the strip sheet.

In the case that at least a portion of one side of the strip sheet is covered in a coating layer, the surface of the strip sheet that contacts the plurality of conveyor rollers composing the first spiral route can be a surface that is not covered by the coating layer, and the surface of the strip sheet that contacts the plurality of conveyor rollers composing the second spiral route can be a surface covered in the coating layer.

For example, in the conveying device 100′ shown in FIG. 1, the surface contacting the plurality of conveyor rollers 1a, 1b, . . . , 1h and 1i composing the first spiral route (indicated with a bold line) is a surface not covered in a coating layer, and the surface contacting the plurality of conveyor rollers 2a, 2b, . . . , 2h and 2i composing the second spiral route (indicated with a bold line) is a surface covered in a coating layer.

Thus, the coating layer covering at least a portion of one surface of the strip sheet can undergo treatment described below at the first spiral route without the untreated coating layer contacting the conveyor roller. Conversely, since the treated coating layer is not affected even when contacting the conveyor rollers, it can be conveyed to the next step while contacting the conveyor rollers in the second spiral route.

The thickness of the coating layer is not particularly limited, and can be, for example, not less than 0.1 μm, not less than 0.5 μm, not less than 1 μm, not less than 2 μm, not less than 3 μm, not less than 4 μm, not less than 5 μm, not less than 6 μm, not less than 7 μm, not less than 8 μm, not less than 9 μm, not less than 10 μm, not less than 15 μm, not less than 20 μm, not less than 30 μm, not less than 40 μm, or not less than 50 μm, and not more than 150 μm, not more than 100 μm, not more than 50 μm, not more than 20 μm, not more than 10 μm, or not more than 5 μm. Depending on the content of the treatment described below, the thickness of the untreated coating layer and the thickness of the treated coating layer can be different.

The material of the coating layer is not particularly limited and materials appropriate for the purpose and use can be used.

For example, in the case of manufacturing an electrode body for a battery, the coating layer can be an active material layer or a solid electrolyte layer.

### (Active Material Layer)

If the coating layer is an active material layer, a positive electrode active material layer slurry or negative electrode active material layer slurry can be applied on the strip sheet.

### 1. Positive Electrode Active Material Layer Slurry

The positive electrode active material layer slurry can comprise positive electrode active material particles, solid electrolyte particles and an optionally addable conductive aid, binder, or solvent.

### 1-1. Positive Electrode Active Material Particles

The positive electrode active material particles can be, for example, lithium cobalt oxide (LiCoO₂), lithium nickel oxide (LiNiO₂), lithium manganese oxide (LiMn₂O₄), and a heterogeneous element substituted Li—Mn spinel having a composition expressed by LiCo_{1/3}Ni_{1/3}Mn_{1/3}O₂, or Li₁₊ₓMn_{2-x-y}M_{y}O₄ (where M is one or more metal elements selected from Al, Mg, Co, Fe, Ni, and Zn), but are not limited thereto.

### 1-2. Solid Electrolyte Particles

The solid electrolyte particles can be, for example, sulfide solid electrolyte particles of Li₂S—P₂S₅-based (Li₇P₃S₁₁, Li₃PS₄, Li₈P₂S₉), Li₂S—SiS₂, LiI—Li₂S—SiS₂, LiI—Li₂S—P₂S₅, LiI—LiBr—Li₂S—P₂S₅, Li₂S—P₂S₅—GeS₂ (Li₁₃GeP₃S₁₆, Li₁₀GeP₂S₁₂), LiI—Li₂S—P₂O₅, LiI—Li₃PO₄—P₂S₅, or Li₇₋ₓPS₆₋ₓClₓ, acidified solid electrolyte particles of Li₇La₃Zr₂O₁₂, Li₇₋ₓLa₃Zr₁₋ₓNbₓO₁₂, Li₇₋₃ₓLa₃Zr₂AlₓO₁₂, Li₃ₓLa_{2/3-x}TiO₃, Li₁₊ₓAlₓTi₂₋ₓ(PO₄)₃, Li₁₊ₓAlₓGe₂₋ₓ(PO₄)₃, Li₃PO₄, or Li₃₊ₓPO₄₋ₓNₓ (LiPON), or polymer electrolyte particles of polyethylene oxide (PEO) or polypropylene oxide (PPO).

### 1-3. Conductive Aid

The conductive aid can be, for example, a carbon material such as VGCF (vapor grown carbon fiber) and carbon nanofibers, or a metal material, but is not limited thereto.

### 1-4. Binder

The binder can be, for example, a material such as polyvinylidene fluoride (PVdF), carboxymethyl cellulose (CMC), butadiene rubber (BR) and styrene butadiene rubber (SBR), but is not limited thereto.

### 1-5. Solvent

The solvent can be a nonpolar solvent such as heptane, xylene, or toluene, or a polar solvent such as a tertiary amine solvent, ether solvent, thiol solvent, or ester solvent (for example, butyl butyrate), but is not limited thereto.

### 2. Negative Electrode Active Material Slurry

The negative electrode active material slurry may comprise negative electrode active material particles, solid electrolyte particles, and an optionally added conductive aid, binder, or solvent.

### 2-1. Negative Electrode Active Material Particles

The negative electrode active material particles can be negative electrode active material particles of, for example, an oxide such as lithium titanate (LTO), an alloy such as a Si alloy or Sn alloy, or a carbon material such as hard carbon, soft carbon, and graphite, but are not limited thereto.

Regarding the solid electrolyte particles and the optionally selectable conductive aid, binder, and solvent, which can be included in the negative electrode active material layer slurry, refer to the substances indicated under the items “1.2 Solid electrolyte particles”, “1.3 Conductive aid”, “1.4 Binder”, and “1.5 Solvent” above.

In the case that the coating layer is a solid electrolyte layer, a solid electrolyte layer slurry can be applied onto the strip sheet.

### (Solid Electrolyte Layer Slurry)

The solid electrolyte layer slurry can comprise solid electrolyte particles and optionally addable conductive aid, binder, or solvent.

Regarding the solid electrolyte particles and the optionally addable conductive aid, binder, and solvent, which can be contained in the solid electrolyte layer slurry, refer to the substances indicated under the items “1.2 Solid electrolyte particles”, “1.3 Conductive aid”, “1.4 Binder”, and “1.5 Solvent” above.

### (Treatment Agent)

The starting material for the treatment agent layer (i.e., the treatment agent of the treatment agent layer) is not particularly limited, and can be an etchant or a treatment liquid for patterning.

The etchant is not particularly limited, and can be appropriately selected in accordance with the layer to be removed. The etchant for removing at least a portion of the metal layer can be a cupric chloride aqueous solution, a ferric chloride aqueous solution, or an aqueous solution of phosphoric acid, acetic acid, or nitric acid. The etchant for removing the transparent conductive layer can be an oxalic acid aqueous solution, hydrochloric acid, or aqua regia.

The treatment liquid for patterning is not particularly limited, and can be appropriately selected in accordance with the layer for the purpose of patterning and optionally with the mask layer below. The etchant for patterning the metal layer can be cupric chloride aqueous solution, ferric chloride aqueous solution, or an aqueous solution of phosphoric acid, acetic acid, and nitric acid. Additionally, the etchant for patterning the transparent conductive layer can be an oxalic acid aqueous solution, hydrochloric acid, or aqua regia.

### <Treatment Apparatus>

The conveying device of the present disclosure may further comprise a treatment apparatus for treating a coating layer or treatment agent layer, which is untreated, in the double spiral route to obtain the coating layer which has been treated or a strip sheet which has been surface treated.

This treatment apparatus is not particularly limited and can be at least one of a drying apparatus and a chemical treatment apparatus.

### (Drying Apparatus)

When treating the coating layer or the treatment agent layer, the coating layer or treatment agent layer can be naturally dried in the drying apparatus or can be dried by the drying apparatus.

If the coating layer or treatment agent layer is dried by the drying apparatus, the drying apparatus can have at least one selected from the group consisting of a fan, ultrasonic oscillator, heater, and decompressor.

### (Chemical Treatment Apparatus)

When treating the coating layer or the treatment agent layer, the coating layer or treatment agent layer can be chemically treated by a chemical treatment apparatus. In particular, by chemically treating the treatment agent layer with a chemical treatment apparatus, a surface-treated strip sheet can be obtained.

This chemical treatment apparatus can have at least one selected from the group consisting of a curing apparatus, water repellent treatment apparatus, hydrophilic apparatus, and plasma, treatment apparatus.

### <<Conveying Method>>

The present disclosure provides a conveying method.

The conveying method of the present disclosure is a conveying method using the above conveying device of the present disclosure, and comprises:

contacting a surface of a strip sheet covered in a coating layer or a treatment agent layer and the surface of the opposite side with a plurality of conveyor rollers composing a first spiral route, and

contacting a surface of the strip sheet covered in a coating layer or a surface of the strip sheet surface treated by a treatment agent of the treatment agent layer with a plurality of conveyor rollers composing a second spiral route.

For example, in the case of using the conveying device 100′ shown in FIG. 1, the conveying method of the present disclosure comprises contacting the surface of the strip sheet 10 covered in a coating layer and the surface on the opposite side with the plurality of conveyor rollers 1a, 1b, . . . , 1h, and 1i composing the first spiral route (indicated with a bold line), and contacting the surface of the strip sheet 10 covered in a coating layer with a plurality of conveyor rollers 2a, 2b, . . . , 2h, and 2i composing the second spiral route (indicated with a fine line).

### <<Method for Manufacturing the Coating Layer>>

The present disclosure provides a method for manufacturing a coating layer.

The method for manufacturing a coating layer of the present disclosure uses the above conveying means of the present disclosure, and comprises treating an untreated coating layer in the double spiral route, to obtain a treated coating layer.

The “untreated coating layer” refers to a coating layer, which has been just applied and yet to undergo the “treatment” described below. Additionally, the “treated coating layer” refers to a coating layer which has undergone the “treatment” described below.

“Treatment” in the present disclosure refers to a physical or chemical means performed on a coating layer in accordance with purpose and use.

More specifically, the treatment can be at least one of a drying treatment and a chemical treatment.

When performing a drying treatment, the above drying apparatus can be used.

Likewise, when performing a chemical treatment, the above chemical treatment apparatus can be used.

In the case of performing drying treatment, the treated coating layer can be absolutely dry. In this case, absolute drying treatment can be performed on, for example, the second spiral route. “Absolutely drying” refers to the process of further drying, and removing all residual solvent in the case that residual solvent (for example, water or an organic solvent) is unnecessary for the product even if solvent removal enabled the coating layer to contact the conveyor roller.

Using the method of the present disclosure, a coating layer which is an active material layer or a solid electrolyte layer used in a battery can be manufactured.

### <Method for Manufacturing the Active Materials Layer>

In the method of the present disclosure, the steps for manufacturing an active materials layer are not particularly limited, but can be performed, for example, using steps 1 to 3 below.

### (Step 1)

In step 1, a positive electrode active material layer slurry or a negative electrode active material layer slurry is applied to one surface of a strip sheet, such that at least a portion of one surface of the strip sheet is covered in an active material layer.

### (Step 2)

In step 2, the surface of the strip sheet covered in an active material layer and the opposite surface are set so as to contact the plurality of conveyor rollers composing the first spiral route, and so the surface of the strip sheet covered in the active material layer contacts the plurality of conveyor rollers composing the second spiral route.

### (Step 3)

In step 3, within a conveying device having a drying apparatus, the active material layer before treatment is dried in the double spiral route to obtain an active material layer in an “absolutely dry” state.

The drying means is not particularly limited, and can be at least one of, for example, natural drying, hot air drying, IR heating drying, microwave heating drying, ultrasonic drying, and vacuum drying.

Thus, a strip sheet with an active material layer can be manufactured. If, for example, it is necessary to transfer only the active material layer to another substrate or laminate body, it is possible to separate the strip sheet and the active material layer in a subsequent step.

If a material which could be a current collector described above is used as the strip sheet, it is possible to manufacture a laminate body of an active material layer having a current collector layer.

### <Method for Manufacturing the Solid Electrolyte Layer>

It is possible to manufacture a solid electrolyte layer using the method of the present disclosure. For example, in steps 1 to 3 above, by using a solid electrolyte layer slurry in place of the active material layer slurry, it is possible to manufacture a strip sheet having a solid electrolyte layer. If, for example, it is necessary to transfer only the solid electrolyte layer to another substrate or laminate body, it is possible to separate the strip sheet and the active material layer in a subsequent step.

### <<Method for Manufacturing the Surface Treated Strip Sheet>>

The present disclosure also provides a method for manufacturing a surface treated strip sheet.

The method for manufacturing the surface treated strip sheet of the present disclosure comprises using the above conveying method of the present disclosure and surface treating the strip sheet by a treatment agent of the treatment agent layer in the double spiral route.

### EXAMPLES

### Example 1

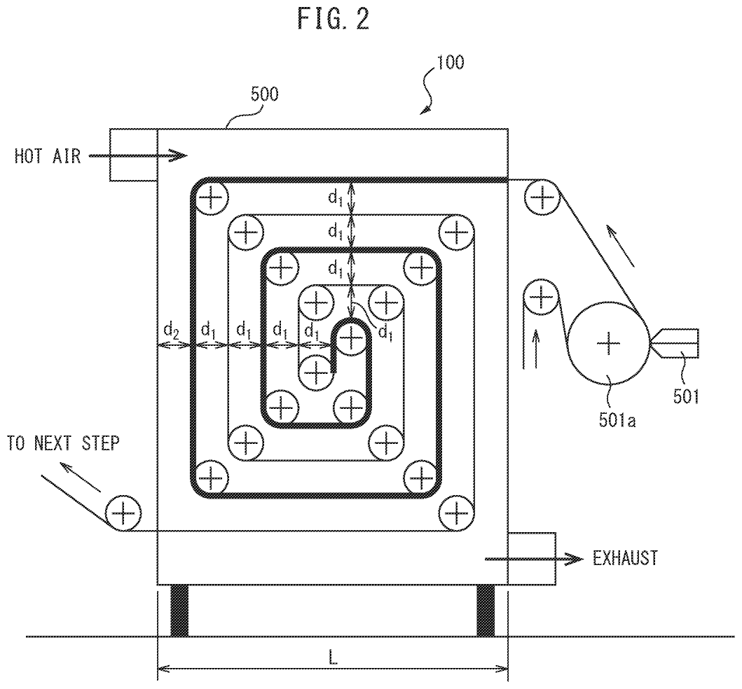

In the case of drying a coating layer covering one surface of a strip sheet in drying furnace 500 using conveying device 100 shown in FIG. 2, the distance d₃ (i.e., the length of the first spiral route shown with a bold line) along which the coating layer is conveyed within the drying furnace 500 without contacting conveyor rollers was calculated.

The following parameters (i) to (iv) were used in the calculation:
(i) The diameter of all conveyor rollers in the drying furnace 500 are taken to be a;
(ii) The interval d1 between the first spiral route within the drying furnace and the second spiral route is set to be constant and equal to the diameter a for all conveyor rollers (d₁=a);
(iii) The length of the drying furnace 500 is taken as L and L is set to L=10a;
(iv) The distance d₂ along the length of the drying furnace 500 between the outer side of the spiral conveying route and the side wall of the drying furnace 500 is set to be equal to the diameter a of the conveyor rollers (d₂=a).

As a result of the calculation, the distance d₃ along which the coating layer of Example 1 was conveyed within the drying furnace 500 without contacting the conveyor rollers was 48.6a.

### Comparative Example 1

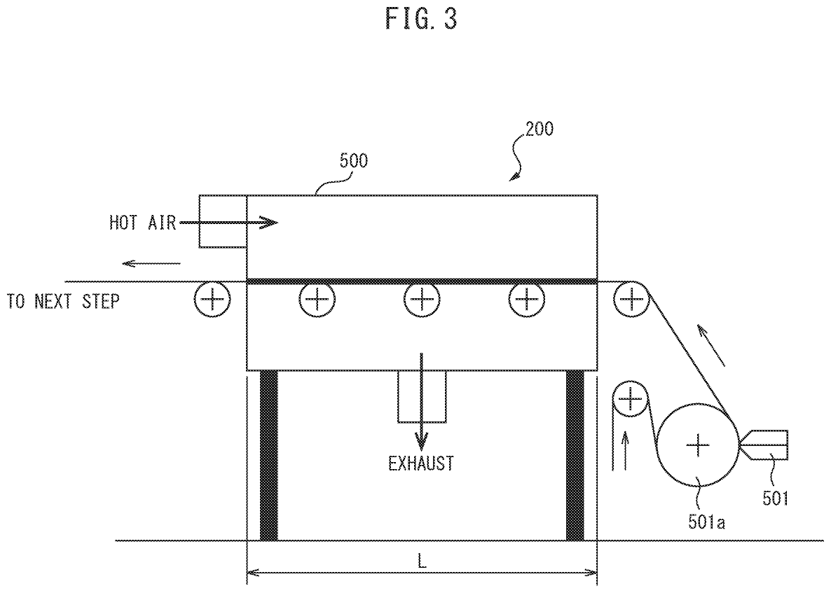

In the case of drying a coating layer covering one surface of a strip sheet in drying furnace 500 using conveying device 200 shown in FIG. 3, the distance d₃ (i.e., the length of the first spiral route shown with a bold line) along which the coating layer was conveyed within the drying furnace 500 without contacting conveyor rollers was calculated.

The parameters for the calculation are the same as the parameters (i) to (iv) in Example 1.

As a result of the calculation, the distance d₃ along which the coating layer of Comparative Example 1 was conveyed within the drying furnace 500 without contacting the conveyor rollers was the same as the length L of the drying furnace 500, which is 10a.

### Comparative Example 2

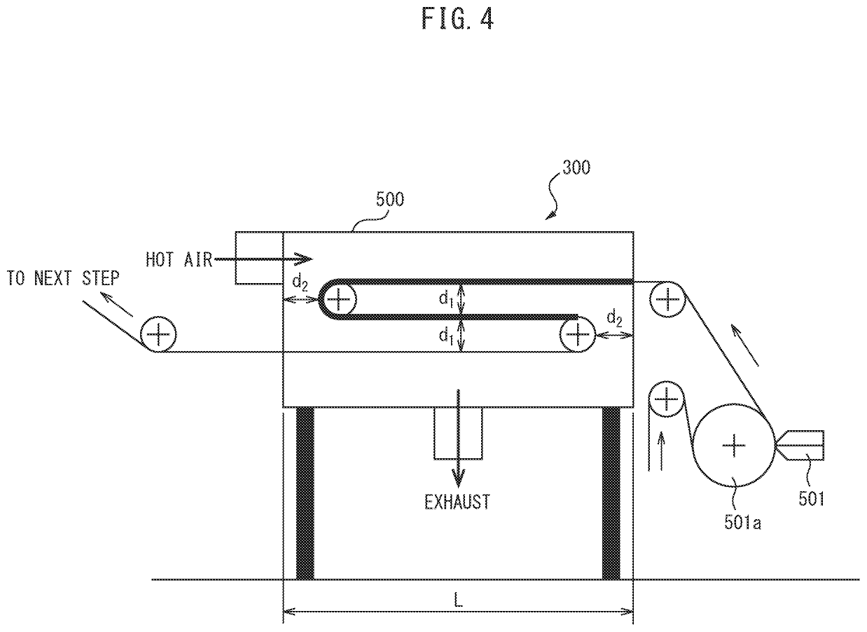

In the case of drying a coating layer covering one surface of a strip sheet in drying furnace 500 using conveying device 300 shown in FIG. 4, the distance d₃ (i.e., the length of the first spiral route shown with a bold line) along which the coating layer was conveyed within the drying furnace 500 without contacting conveyor rollers was calculated.

The parameters for the calculation are the same as the parameters (i) to (iv) in Example 1.

As a result of the calculation, the distance d₃ along which the coating layer of Comparative Example 2 was conveyed within the drying furnace 500 without contacting the conveyor rollers was 17.1a.

### Comparative Example 3

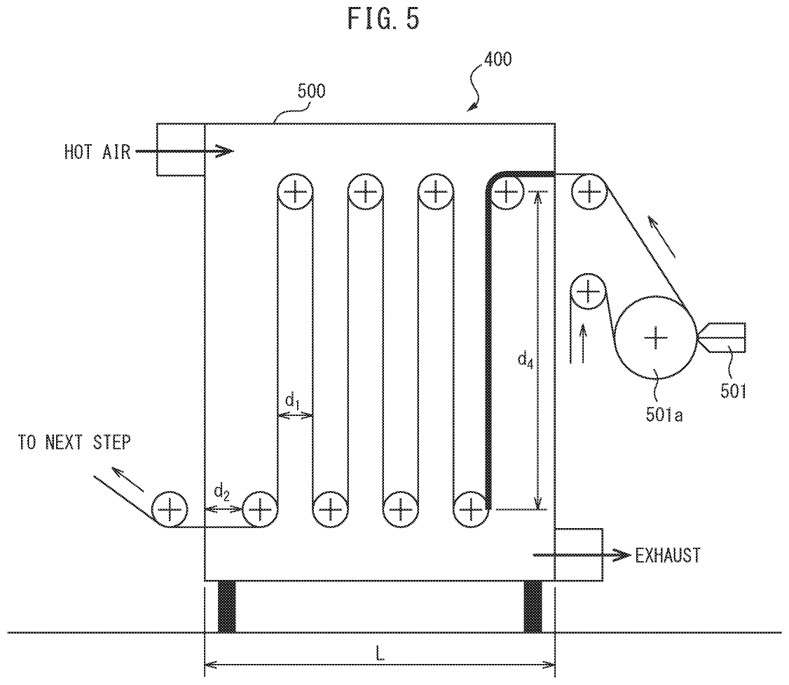

In the case of drying a coating layer covering one surface of a strip sheet in drying furnace 500 using conveying device 400 shown in FIG. 5, the distance d₃ (i.e., the length of the first spiral route shown with a bold line) along which the coating layer was conveyed within the drying furnace 500 without contacting conveyor rollers was calculated.

The parameters for the calculation include the same parameters (i) to (iv) in Example 1 and also the following parameter (v).
(v) The pitch d₄ between rollers in the vertical direction (vertical direction relative to the length direction of the drying furnace) of the drying furnace 500 is set to be 9a, about the maximum distance in the vertical direction for the double spiral route within the drying furnace 500 of Example 1.

As a result of the calculation, the distance d₃ along which the coating layer of Comparative Example 3 was conveyed within the drying furnace 500 without contacting the conveyor rollers was 11.3a

### <<Comparison of Results>>

The results of the calculations for Example 1, and Comparative Examples 1 to 3 above are shown in Table 1 below. For the sake of ease of comparison, the results of Example 1 and Comparative Examples 2 and 3 are each compared with Comparative Example 1 in Table 1.

TABLE 1

| | | Value from dividing by distance d₃ of |
|---|---|---|
| | Distance d₃ *¹ | Comparative Example 1 |
| Example 1 | 48.6a | 4.86 |
| Comparative | 10a | 1 |
| Example 1 | | |
| Comparative | 17.1a | 1.71 |
| Example 2 | | |
| Comparative | 11.3a | 1.13 |
| Example 3 | | |

*¹Distances d₃ are the distances along which the coating layers of the Example and Comparative Examples were conveyed within the drying furnace 500 without contacting the conveyor rollers.

This “distance d₃” is considered to be an index of the extent to which improvement in the production efficiency of a target and reduction of costs of the apparatus can both be achieved. Essentially, the longer the “distance d₃” is, the greater improvement in the production efficiency and reduction of costs of the apparatus.

Thus, as shown clearly in Table 1, Example 1 was best able to achieve both improvement in the production efficiency of the target and reduction of costs of the apparatus.

### REFERENCE SIGNS LIST

1a, 1b, 1c, 1d, 1e, 1f, 1g, 1h, 1i Conveyor rollers composing the first spiral route
2a, 2b, 2c, 2d, 2e, 2f, 2g, 2h, 2i Conveyor rollers composing the second spiral route
10 Strip sheet
100′, 100, 200, 300, 400 Conveying device
500 Drying furnace
501 Coating die
501a Backup roller

What is claimed is:

1. A conveying device for conveying a strip sheet, comprising a double spiral route comprising a first spiral route from an outer side toward a center side and a second spiral route from the center side toward. an outer side connected successively in this order, wherein the first spiral route and the second spiral route are each composed of a plurality of conveyor rollers.

2. The conveying device according to claim wherein the first spiral route and the second spiral route are both angular spirals.

3. The conveying device according to claim 2, wherein the angular spirals are square spirals.

4. The conveying device according to claim 1, wherein a gap between the first spiral route and the second spiral route is substantially constant.

5. The conveying device according to claim 1, wherein at least a part of one surface of the strip sheet is covered by a coating layer or a treatment agent layer.

6. The conveying device according to claim 5, further comprising a treatment apparatus for treating the coating layer or treatment agent layer, which is untreated, in the double spiral route to obtain the coating layer which has been treated or the strip sheet which has been surface treated.

7. The conveying device according to claim 6, wherein the treatment apparatus is at least one of a drying apparatus and a chemical treatment apparatus.

8. The conveying device according to claim 7, wherein the drying apparatus is at least one selected from the group consisting of a fan, an ultrasonic oscillator, a heater, and a decompressor.

9. The conveying device according to claim 7, wherein the chemical treatment apparatus is at least one selected from the group consisting of a curing apparatus, a water repellent treatment apparatus, a hydrophilic treatment apparatus, and a plasma treatment apparatus.

10. The conveying device according to claim 5, wherein a raw material of the coating layer is an active material layer slurry or a solid electrolyte layer slurry.

11. The conveying device according to claim 5, wherein a raw material of the treatment agent layer is an etchant or a treatment liquid for patterning.

12. A conveying method using the conveying device according to claim 5, comprising contacting a surface of the strip sheet covered by the coating layer or the treatment agent layer, and the opposite surface thereof with the plurality of conveyor rollers composing the first spiral route, and contacting the surface of the strip sheet covered by the coating layer, or a surface of the strip sheet surface treated with a treatment agent of the treatment agent layer with the plurality of conveyor rollers composing the second spiral route.

13. A method for manufacturing a coating layer, comprising using the conveying method according to claim 12 to treat the coating layer, which is untreated, in the second spiral route, and obtain the coating layer which has been treated.

14. The method according to claim 13, wherein the treatment is at least one of a drying treatment and a chemical treatment.

15. The method according to claim 14, wherein the drying treatment is at least one of a natural drying treatment, a hot air drying treatment, an IR heat drying treatment, a microwave heat drying treatment, an ultrasonic drying treatment, and a vacuum drying treatment.

16. The method according to claim 13, wherein the coating layer is an active material layer or a solid electrolyte layer.

17. A method for manufacturing a surface treated strip sheet, comprising surface treating a strip sheet with a treatment agent of the treatment agent layer in a double spiral route, using the conveying method according to claim 12.
